(19) United States
(12) Patent Application Publication
(10) Pub. No.: US 2009/0109166 A1
(43) Pub. Date: Apr. 30, 2009

(54) LIQUID CRYSTAL DISPLAY AND METHOD OF DRIVING THE SAME

(76) Inventors: Sang-Gil LEE, Seoul (KR); Seung-Hwan Moon, Yongin-si (KR); Ki-Chan Lee, Cheonan-si (KR)

Correspondence Address: Haynes and Boone, LLP;IP Section, 2323 Victory Avenue, SUITE 700, Dallas, TX, 75219, US

(21) Appl. No.: 12/238,201

(22) Filed: Sep. 25, 2008

(30) Foreign Application Priority Data
Oct. 30, 2007 (KR) 10-2007-0109654

(51) Int. Cl. G09G 3/36

(52) U.S. Cl. 345/102

(57) ABSTRACT

A liquid crystal display (LCD) and a method of driving the same are provided. The LCD includes a liquid crystal panel; and a plurality of light-emitting blocks providing light to the liquid crystal panel, the light-emitting blocks including light-emitting elements and wherein a peak value of current flowing through each of the light-emitting elements is controlled according to operation modes.

### CROSS REFERENCE TO RELATED APPLICATION

This application claims priority from Korean Patent Application No. 10-2007-0109654 filed on Oct. 30, 2007 in the Korean Intellectual Property Office, the disclosure of which is incorporated herein by reference in its entirety.

### BACKGROUND OF THE INVENTION

1. Field of the Invention

The present invention relates to a liquid crystal display and a method of driving the same.

2. Description of the Related Art

In general, a liquid crystal display includes a liquid crystal panel that has a first display plate on which pixel electrodes are provided, a second display plate on which a common electrode is provided, and a liquid crystal layer having dielectric anisotropy and which is interposed between the first display plate and the second display plate. An electric field is generated between the pixel electrodes and the common electrode, and the transmittance of the light through the liquid crystal panel is controlled by adjusting the intensity of the electric field, thereby displaying desired images. Since the liquid crystal display is not a self-emission display device, the liquid crystal display includes a plurality of light-emitting blocks.

In recent years, in order to improve display quality, technology has been developed for controlling the luminance of each light-emitting block on the basis of the image displayed on the liquid crystal panel.

### SUMMARY OF THE INVENTION

An object of the invention is to provide a liquid crystal display that has improved display quality.

Another object of the invention is to provide a method of driving a liquid crystal display that has improved display quality.

The above and other objects of the present invention will be described in or will be apparent from the following description of the preferred embodiments.

According to an aspect of the present invention, there is provided a liquid crystal display comprising a liquid crystal panel; and a plurality of light-emitting blocks providing light to the liquid crystal panel, and the light-emitting blocks including light-emitting elements, and wherein a peak value of current flowing through each of the light-emitting elements is controlled according to operation modes.

According to another aspect of the present invention, there is provided a liquid crystal display comprising a liquid crystal panel divided into a plurality of display blocks; a plurality of light-emitting blocks whose luminance is controlled on the basis of images displayed on the corresponding display blocks, and the light-emitting blocks including light-emitting elements; a voltage provider providing a first reference voltage in a first operation mode, and a second reference voltage having a voltage level lower than that of the first reference voltage in a second operation mode; and backlight drivers supplied with the first reference voltage or the second reference voltage and controlling a peak value of current flowing through each of the light-emitting elements, wherein the peak value of the current in the first operation mode is larger than that the current flowing in the second operation mode.

According to still another aspect of the present invention, there is provided a method of driving a liquid crystal display that includes a liquid crystal panel, and a plurality of light-emitting blocks providing light to the liquid crystal panel and the light-emitting blocks including light-emitting elements the method comprising controlling a peak value of current flowing through each of the light-emitting elements according to operation modes; and receiving light from the light-emitting blocks and displaying images.

### BRIEF DESCRIPTION OF THE DRAWINGS

FIG. 1 is a block diagram illustrating a liquid crystal display and a method of driving the same according to an embodiment of the invention;

FIG. 2 is a pictorial and circuit diagram of one pixel;

FIG. 3 is a block diagram illustrating the arrangement of light-emitting blocks and a connection relation between the light-emitting blocks and backlight drivers in the structure shown in FIG. 1;

FIG. 4A is a conceptual diagram illustrating the operation of a plurality of light-emitting blocks in a second operation mode;

FIG. 4B is a timing diagram illustrating the operation of each light-emitting block in a second operation mode;

FIG. 5A is a conceptual diagram illustrating the operation of a plurality of light-emitting blocks in a first operation mode;

FIG. 5B is a timing diagram illustrating the operation of each light-emitting block in a first operation mode;

FIG. 6 is a circuit diagram illustrating the voltage provider shown in FIG. 1;

FIG. 7 is a circuit diagram illustrating a circuit implementation of the variable resistor 910 shown in voltage provider shown in FIG. 6;

FIG. 8 is a circuit diagram illustrating a backlight driver shown in FIG. 1; and

FIG. 9 is a circuit diagram illustrating the liquid crystal display and a method of driving the same according to another embodiment of the invention.

### DETAILED DESCRIPTION OF THE PREFERRED EMBODIMENTS

Advantages and features of the present invention and methods of accomplishing the same will be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that, although the terms first, second and other terms may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

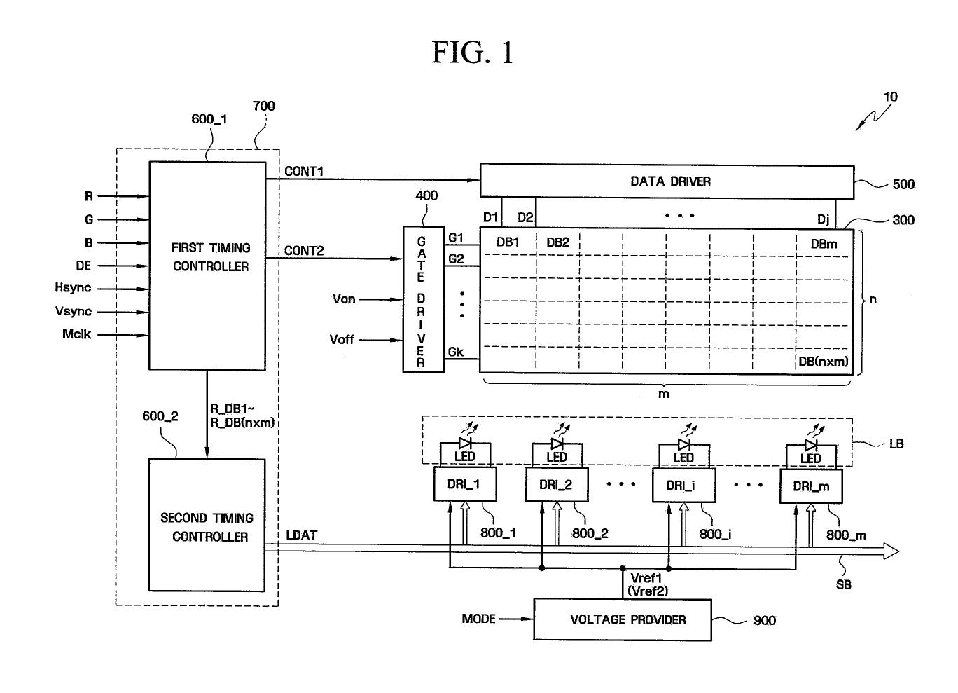

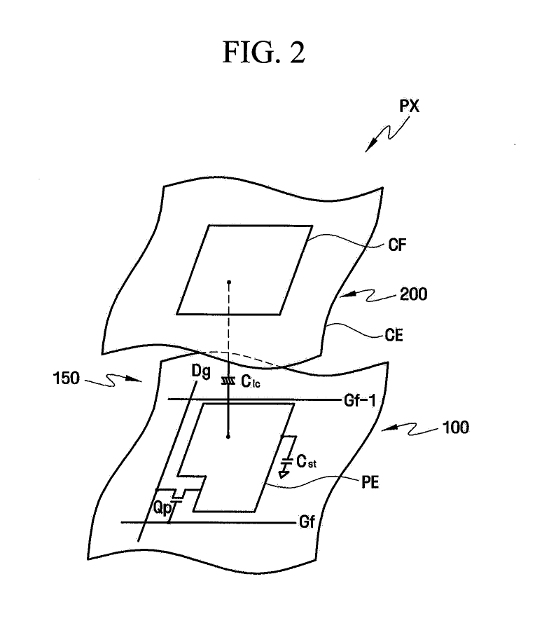

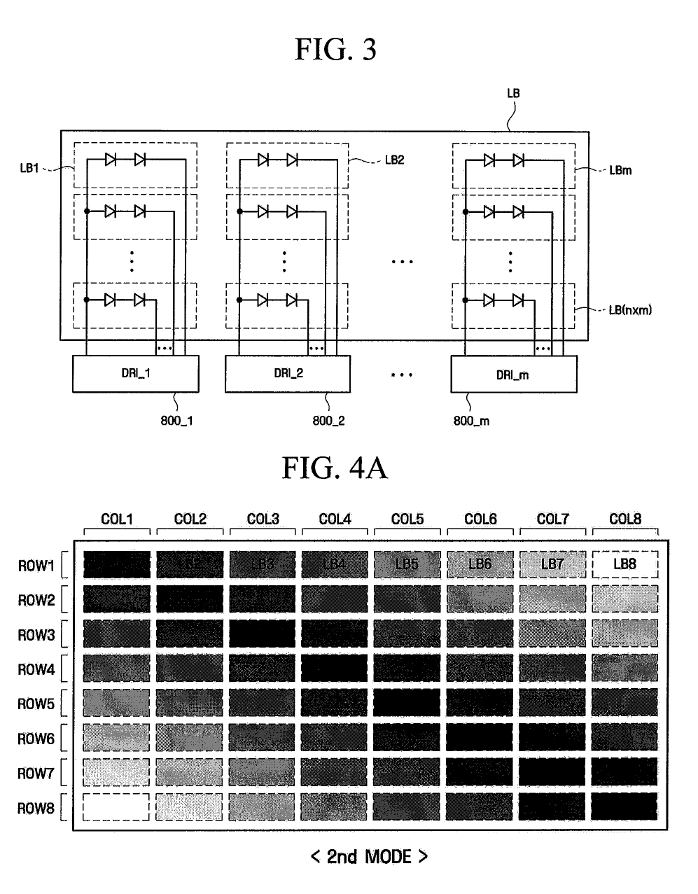

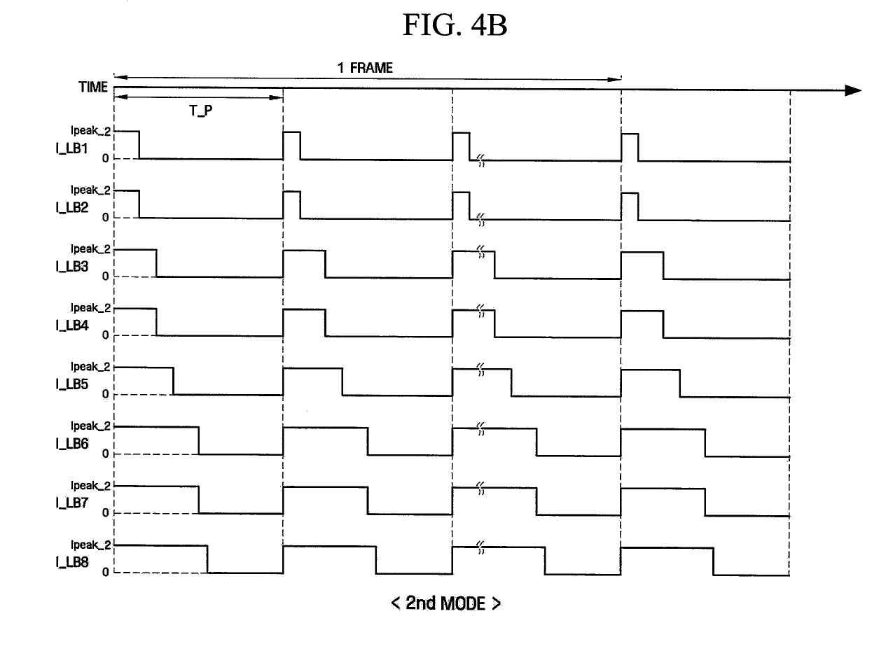

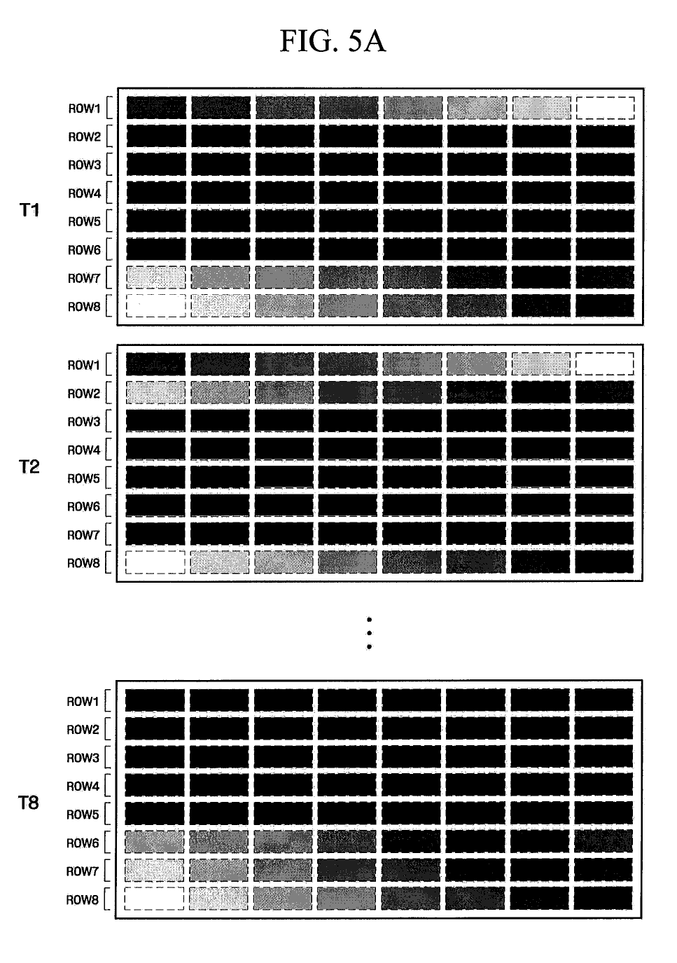

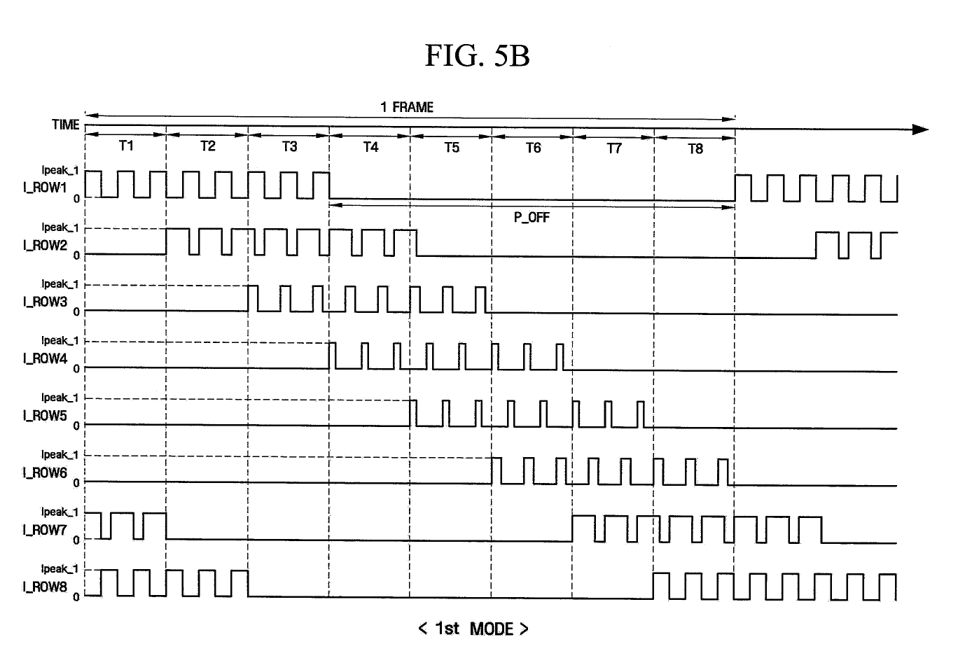

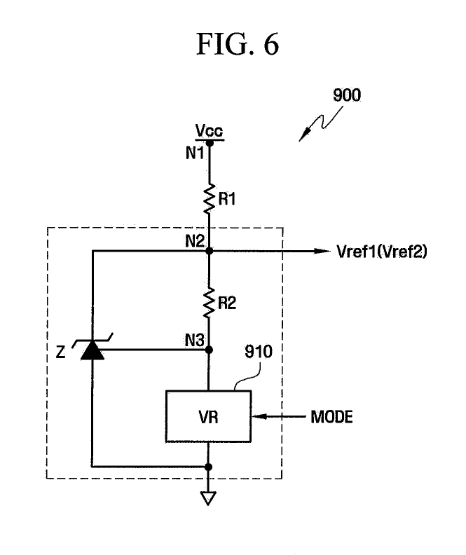

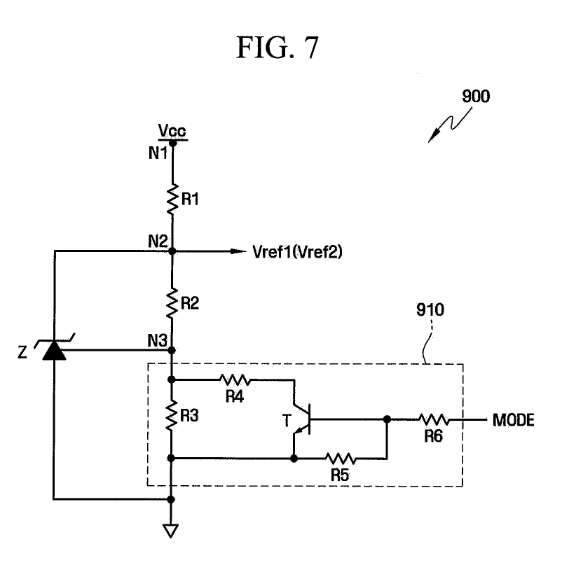

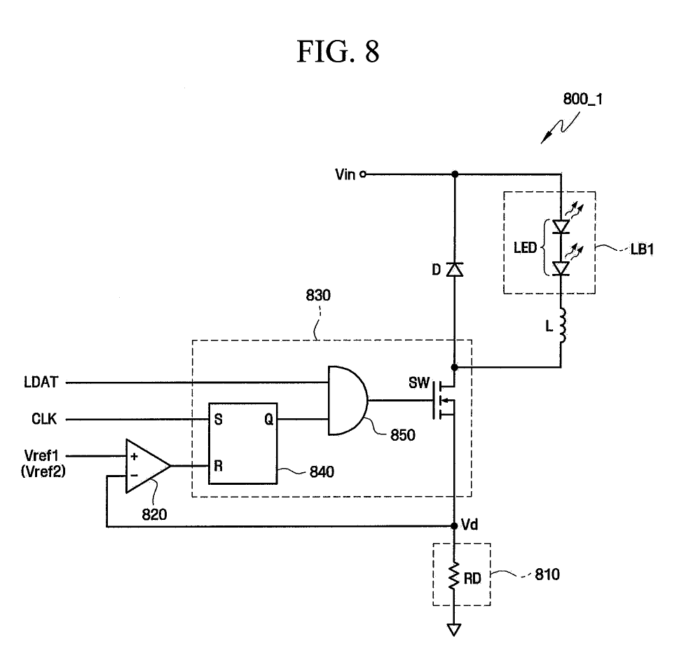

A liquid crystal display and a method of driving the same according to an embodiment of the invention will be described with reference to FIGS. 1 to 8. FIG. 1 is a block diagram illustrating a liquid crystal display and a method of driving the same according to an embodiment of the invention. FIG. 2 is an equivalent circuit diagram of one pixel. FIG. 3 is a block diagram illustrating the arrangement of light-emitting blocks and a connection relation between the light-emitting blocks and backlight drivers in the structure shown in FIG. 1. FIG. 4A is a conceptual diagram illustrating the operation of a plurality of light-emitting blocks in a second operation mode. FIG. 4B is a timing chart illustrating the operation of each light-emitting block in a second operation mode. FIG. 5A is a conceptual diagram illustrating the operation of a plurality of light-emitting blocks in a first operation mode. FIG. 5B is a timing chart illustrating the operation of each light-emitting block in a first operation mode. FIG. 6 is a circuit diagram illustrating the voltage provider shown in FIG. 1. FIG. 7 is a circuit diagram illustrating the variable resistor shown in FIG. 6. FIG. 8 is a circuit diagram illustrating the backlight driver shown in FIG. 1.

Referring to FIG. 1, a liquid crystal display 10 includes a liquid crystal panel 300, a gate driver 400, a data driver 500, a timing controller 700, first to m-th backlight drivers 800_1 to 800_{—}m, and light-emitting blocks LB that are connected to the first to m-th backlight drivers 800_1 to 800_{—}m, respectively. In this case, the timing controller 700 may be functionally divided into a first timing controller 600_1 and a second timing controller 600_2. The first timing controller 600_1 may control images displayed on the liquid crystal panel 300, and the second timing controller 600_2 may control the first to m-th backlight drivers 800_1 to 800_{—}m. The first timing controller 600_1 and the second timing controller 600_2 may be physically separated from each other.

The liquid crystal panel 300 may be divided into a plurality of display blocks DB1 to DB(n×m). For example, the plurality of display blocks DB1 to DB(n×m) are arranged in an n×m matrix and correspond to the plurality of light-emitting blocks LB. The plurality of display blocks DB1 to DB(n×m) include a plurality of pixels. The liquid crystal panel 300 includes a plurality of gate lines G1 to Gk and a plurality of data lines D1 to Dj.

An equivalent circuit of one pixel is shown in FIG. 2. For example, a pixel PX, which is connected to an f-th (f=1 to k) gate line Gf and a g-th (g=1 to j) data line Dg, includes a switching element Qp that is connected to the gate line Gf and the data line Dg, and a liquid crystal capacitor Clc and a storage capacitor Cst that are connected to the switching element Qp. The liquid crystal capacitor Clc includes the pixel electrode PE provided on the first display plate 100 and a common electrode CE provided on the second display plate 200. A color filter CF is formed in a portion of the common electrode CE.

Referring to FIG. 1, the gate driver 400 receives a gate control signal CONT2 from the first timing controller 600_1 and applies gate signals to the gate lines G1 to Gk. In this case, the gate signal is composed of a combination of a gate on voltage Von and a gate off voltage Voff, which are supplied from a gate on/off voltage generator (not shown). The gate control signal CONT2 controls the operation of the gate driver 400, and may include a vertical start signal that starts the operation of the gate driver 400, a gate clock signal that determines an output point of time of the gate on voltage, and an output enable signal that determines a pulse width of the gate on voltage.

The data driver 500 receives a data control signal CONT1 from the first timing controller 600_1 and applies image data voltages to the data lines D1 to Dj. The data control signal CONT1 includes image data signals that correspond to R, G, and B image signals R, G, and B and a signal to control the operation of the data driver 500. The signal to control the operation of the data driver 500 may include a horizontal start signal that starts the operation of the data driver 500 and an output instruction signal that instructs the output of the image data voltages.

The gate driver 400 or the data driver 500 is mounted on a flexible printed circuit film (not shown) and may adhere to the liquid crystal panel 300 in the form of a tape carrier package. Alternatively, the gate driver 400 or the data driver 500 may be integrated in the liquid crystal panel 300 together with the display signal lines G1 to Gk and D1 to Dj and the switching elements Qp.

The timing controller 700 receives the R, G, and B image signals R, G, and B and external control signals Vsync, Hsync, Mclk, and DE to control the display of the R, G, and B image signals, and outputs the data control signal CONT1, the gate control signal CONT2, and an optical data signal LDAT. The timing controller 700 may provide the optical data signal LDAT to correspond to an image displayed by each of the display blocks DB1 to DB(n×m). That is, the timing controller 700 may provide the optical data signal LDAT such that each of the light-emitting blocks is controlled on the basis of an image displayed by each of the display blocks DB1 to DB(n×m).

Specifically, the first timing controller 600_1 receives the R, G, and B image signals R, G, and B and the external control signals Vsync, Hsync, Mclk, and DE to control the display thereof from an external graphic controller (not shown). The first timing controller 600_1 generates the data control signal CONT1 and the gate control signal CONT2 on the basis of the R, G, and B image signals R, G, and B and the external control signals Vsync, Hsync, Mclk, and DE. Examples of the external control signals include a vertical synchronization signal Vsync, a horizontal synchronization signal Hsync, a main clock signal Mclk, and a data enable signal DE.

The first timing controller 600_1 provides representative image signals R_DB1 to R_DB(n×m) corresponding to the display blocks DB1 to DB(n×m) to the second timing controller 600_2, such that the second timing controller 600_2 outputs the optical data signal LDAT corresponding to an image displayed by each of the display blocks DB1 to DB(n×m). That is, the first timing controller 600_1 receives the R, G, and B image signals R, G, and B, determines the representative image signals R_DB1 to R_DB(n×m) corresponding to the individual display blocks DB1 to DB(n×m), and provides the determined representative image signals R_DB1 to R_DB(n×m) to the second timing controller 600_2. In this case, the representative image signals R_DB1 to R_DB(n×m) may be representative values of the R, G, and B image signals R, G, and B that are provided to the display blocks DB1 to DB(n×m). For example, the first timing controller 600_1 receives the R, G, and B image signals R, G, and B that are provided to the first display block DB1, determines a representative image signal R_DB1 as a representative value of the R, G, and B image signals R, G, and B that are provided to the first display block DB1, and outputs the determined representative image signal R_DB1 to the second timing controller 600_2. Then, the first timing controller 600_1 receives the R, G, and B image signals R, G, and B that are provided to the second display block DB2, determines a representative image signal R_DB2 as a representative value of the R, G, and B image signals R, G, and B that are provided to the second display block DB2, and outputs the determined representative image signal R_DB2 to the second timing controller 600_2.

In this way, the first timing controller 600_1 determines the representative image signals R_DB1 to R_DB(n×m) that correspond to the plurality of display blocks DB1 to DB(n×m), and outputs the determined representative image signals to the second timing controller 600_2. In this case, the representative image signals R_DB1 to R_DB(n×m) that correspond to the display blocks DB1 to DB(n×m) may be average values of the R, G, and B signals R, G, and B that are provided to the display blocks DB1 to DB(n×m). Alternatively, the representative image signals R_DB1 to R_DB(n×m) may be maximum values of the R, G, and B signals R, G, and B that are provided to the display blocks DB1 to DB(n×m). However, the above-described method is only exemplary, and does not limit the method in which the first timing controller 600_1 determines the representative image signals R_DB1 to R_DB(n×m) corresponding to the display blocks DB1 to DB(n×m).

The second timing controller 600_2 receives the representative image signals R_DB1 to R_DB(n×m), and provides the optical data signal LDAT corresponding to the representative image signals R_DB1 to R_DB(n×m) to the first to m-th backlight drivers 800_1 to 800_{—}m. Here, the optical data signal LDAT may be a signal that corresponds to an image displayed by each of the display blocks DB1 to DB(n×m), as described above. The optical data signal LDAT may be provided to each of the backlight drivers 800_1 to 800_{—}m through a serial bus SB.

A voltage provider 900 provides a first reference voltage Vref1 in a first operation mode and a second reference voltage Vref2 in a second operation mode. The level of the first reference voltage Vref1 may be higher than that of the second reference voltage Vref2. The voltage provider 900 receives an operation mode signal MODE from the outside, and provides the first reference voltage Vref1 or the second reference voltage Vref2 in response to the operation mode signal MODE. The operation mode signal MODE may be a signal indicating whether the light-emitting blocks LB1 to LB(n×m) operate in the first operation mode or the second operation mode. The operation mode signal MODE may be provided from the first timing controller 600_1 or the second timing controller 600_2. The operation and internal circuit of the voltage provider 900 is described below with reference to FIGS. 6 and 7.

The backlight drivers 800_1 to 800_{—}m are supplied with the first reference voltage Vref1 in the first operation mode and the second reference voltage Vref2 in the second operation mode, and control the luminances of the light-emitting blocks LB1 to LB(n×m) in response to the optical data signal LDAT. The operation and internal circuit of each of the backlight drivers 800_1 to 800_{—}m is described below with reference to FIG. 8.

The plurality of light-emitting blocks LB1 to LB(n×m) may be arranged, for example, as shown in FIG. 3. That is, the light-emitting blocks LB1 to LB(n×m) may be arranged in a matrix of n×m to correspond to the display blocks DB1 to DB(n×m). FIG. 4A shows the case of n=m=8. Each of the light-emitting blocks LB1 to LB(n×m) includes a light-emitting diode (LED) that functions as a light-emitting element. For example, the number of the backlight drivers 800_1 to 800_{—}m is m, and the backlight drivers 800_1 to 800_{—}m are connected to columns of the light-emitting blocks LB1 to LB(n×m) and control the luminance of the light-emitting blocks LB1 to LB(n_m). The operation of the plurality of light-emitting blocks LB1 to LB(n×m) may be divided into a first operation mode and a second operation mode. When the plurality of light-emitting blocks LB1 to LB(n×m) are divided into a plurality of light-emitting groups each having at least one light-emitting block, one frame includes a period in which at least one light-emitting group is turned off in the first operation mode, but does not include the period in the second operation mode. For example, the light-emitting groups may be rows (ROW1 to ROW8) of the plurality of light-emitting blocks LB1 to LB(n×m), and one frame includes a period in which at least one row is turned off in the first operation mode, but does not include the period in the second operation mode. The peak current flowing through the light-emitting diode (LED) in the first operation mode may be larger than the peak current flowing through the light-emitting diode (LED) in the second operation mode.

Hereinafter, the operation of the light-emitting blocks LB1 to LB(n×m) in each of the operation modes is described. For explanatory convenience, the operation of the plurality of light-emitting blocks LB1 to LB(n×m) in the second operation mode is first described with reference to FIGS. 4A and 4B.

FIG. 4A shows the luminances of each of the light-emitting blocks LB1 to LB(n×m). As described above, since the timing controller 700 provides the optical data signal LDAT corresponding to the representative image signals of the display blocks DB1 to DB(n×m) to the backlight drivers 800_1 to 800_{—}m, the luminances of the light-emitting blocks LB1 to LB(n×m) is controlled on the basis of images displayed by the display blocks DB1 to DB(n×m). For example, as shown in FIG. 4A, each of the light-emitting blocks LB1 to LB(n×m) may have a different luminance value.

A method of controlling the luminances of the light-emitting blocks LB1 to LB(n×m) shown in FIG. 4A is shown in FIG. 4B. FIG. 4B is a timing diagram showing a value of a current flowing through the light-emitting diode (LED) of each of the first to eighth light-emitting blocks LB1 to LB8 during one frame. The current flowing through each light-emitting diode (LED) may be a pulse width modulation (simply referred to as ‘PWM’) signal. That is, during one period T_P, peak values Ipeak_2 of currents I_LB1 to I_LB8 flowing through the light-emitting diodes (LEDs) of the light-emitting blocks LB1 to LB(n×m) are the same, but times for which the currents flow are different from each other. For example, the peak values Ipeak_2 of currents flowing through the light-emitting diodes (LEDs) of the first and eighth light-emitting blocks LB1 and LB8 are the same, but during one period T_P, the time for which the current flows through the light-emitting diode (LED) of the first light-emitting block LB1 is shorter than the time for which the current flows through the light-emitting diode (LED) of the eighth light-emitting block LB8. Accordingly, the luminance of the first light-emitting block LB1 is lower than that of the eighth light-emitting block LB8. In brief, the luminance of each of the light-emitting blocks LB1 to LB(n×m) is determined on the basis of the time for which the current flows through the light-emitting diode (LED) of each of the light-emitting blocks LB1 to LB(n×m) during one period T_P, that is, a duty ratio. The duty ratio is determined according to the optical data signal LDAT. In the second operation mode, the light-emitting blocks LB1 to LB(n×m) individually operate. During one frame, there is no period in which the light-emitting groups, for example, the rows (ROW1 to ROW8) of the plurality of light-emitting blocks LB1 to LB(n×m) are turned off.

Next, the operation of the plurality of light-emitting blocks LB1 to LB(n×m) in the first operation mode will be described with reference to FIGS. 5A and 5B.

FIG. 5A shows the luminance of the light-emitting blocks LB1 to LB(n×m) that varies over time. The light-emitting blocks LB1 to LB(n×m) that are shown bright operate in the same method as in the second operation mode. That is, the luminance of the light-emitting blocks LB1 to LB(n×m) shown bright is controlled on the basis of images displayed by the corresponding display blocks DB1 to DB(n×m). The light-emitting blocks LB1 to LB(n×m) that are shown dark mean that the light-emitting blocks LB1 to LB(n×m) are turned off for the corresponding times. That is, in the first operation mode, there exists a period in which one or more light-emitting groups, for example, among the eight rows (ROW1 to ROW8), where five rows are turned off.

FIG. 5B is a timing diagram showing currents I_ROW1 to I_ROW8 flowing through light-emitting diodes (LEDs) of rows of the light-emitting blocks, when the light-emitting groups are rows of light-emitting blocks. The operation in the first operation mode is described below in detail with reference to FIGS. 5A and 5B. In the time T1, the luminance of the first, seventh, and the eighth rows (ROW1, ROW7, and ROW8) of the light-emitting blocks LB1 to LB(n×m) is controlled according to the optical data signal LDAT, as in the second operation mode described above, and the second to sixth rows (ROW2 to ROW6) are turned off. Then, in the second time T2, the luminance of the first, second, and eighth rows (ROW1, ROW2, and ROW8) is controlled according to the optical data signal LDAT, and the third to seventh rows (ROW3 to ROW7) are turned off. Then, in the eighth time T8, the luminance of the sixth to eighth rows (ROW6 to ROW8) is controlled according to the optical data signal LDAT, and the first to fifth rows (ROW1 to ROW5) are turned off. That is, in the first operation mode, one frame includes a period P_OFF in which at least one row is turned off. The rows (ROW1 to ROW8) are sequentially turned off. When there exists the period P_OFF in which at least one row is turned off, the display blocks DB1 to DB(n×m) that correspond to the light-emitting blocks LB1 to LB(n×m) turned off during the period P_OFF display black images. In this case, the liquid crystal display 10 may operate like a CRT that displays black images during periods between frames. When the liquid crystal display 10 displays images like a CRT, screen drag can be reduced. That is, in the case where dynamic moving pictures, such as sports images, are displayed, if the light-emitting blocks LB1 to LB(n×m) operate in the above-described method, display quality can be improved.

In this case, the luminance of the light-emitting blocks LB1 to LB(n×m) is controlled according to the optical data signal LDAT during a period of one frame in which the light-emitting blocks are not turned off. For example, the luminance of the first row (ROW1) is controlled according to the optical data signal LDAT for the first to third times T1 to T3, except for the period P_OFF of one frame in which the first row is turned off. At this time, the peak values Ipeak_1 of the currents I_ROW1 to I_ROW8 of the rows (ROW1 to ROW8) are larger than the peak values Ipeak_2 of the currents in the second operation mode. Since there exists the period P_OFF in which at least one row is turned off in the first operation mode, the time, for which the light is emitted from the light-emitting blocks LB1 to LB(n×m) in the first operation mode, is reduced, as can be seen from FIGS. 4B and 5B. However, since the peak values Ipeak_1 of the currents I_ROW1 to I_ROW8 of the rows (ROW1 to ROW8) are larger than the peak values Ipeak_2 of the currents in the second operation mode, the total luminance of the light-emitting blocks LB1 to LB(n×m) in the first operation mode is not lower than that of the light-emitting blocks LB1 to LB(n×m) in the second operation mode.

In brief, if at least one light-emitting group is turned off during a predetermined period of one frame, a screen drag is reduced when dynamic moving pictures, such as sports images, are displayed. It is possible to prevent the total luminance of the light-emitting blocks LB1 to LB(n×m) from being lowered by increasing the peak values Ipeak_1 of the currents flowing through the light-emitting diodes (LEDs) in the first operation mode.

However, the invention is not limited to the above description. That is, in the first operation mode, the light-emitting groups may be columns COL1 to COL8 of the light-emitting blocks LB1 to LB(n×m). The light-emitting blocks may be simultaneously turned off, not being sequentially turned off as shown in FIG. 5B. In the second operation mode described above, the luminance of the light-emitting blocks LB1 to LB(n×m) is controlled on the basis of the duty ratio, but the invention is not limited thereto. The luminance of the light-emitting blocks may be controlled on the basis of the values of the currents flowing through the light-emitting diodes (LEDs).

Hereinafter, a process of providing a current having a large peak value in the first operation mode rather than the second operation mode to the light-emitting diode (LED) is described in detail with reference to FIGS. 6 to 8. First, the voltage provider 900 shown in FIG. 1 will be described with reference to FIG. 6.

Referring to FIG. 6, the voltage provider 900 includes a first resistor R1 and a voltage control unit. In this case, the resistor R1 is connected between an input node N1 supplied with an input voltage Vcc and an output node N2 from which the first reference voltage Vref1 or the second reference voltage Vref2 is output. The voltage control unit is connected between the input node N1 and a ground, and controls a resistance value between the input node N1 and the ground to control a voltage of the output node N2 according to operation mode signals. Specifically, the voltage control unit includes a shunt regulator Z that is connected between the output node N2 and the ground, a second resistor R2 that is connected between the output node N2 and a reference terminal N3 of the shunt regulator Z, and a variable resistor (VR) 910 that is connected between the reference terminal N3 and the ground and has a resistance value varying in response to the operation mode signal MODE. Here, the shunt regulator Z may be a voltage regulator such as a zener diode, avalanche breakdown diode, or voltage regulator tube. The variable resistor 910 has a small resistance value in the first operation mode rather than the second operation mode. For example, the resistance value of the variable resistor 910 decreases when a first-level operation mode signal MODE that instructs the first operation mode is input, and increases when a second-level operation mode signal MODE that instructs the second operation mode is input.

When it is assumed that the voltage of the reference terminal N3 is V_{N3}, the voltage of the output node N2 is V_{N2}, and the resistance value of the variable resistor 910 is Rt, the voltage V_{N2} of the output node N2 may be expressed by Equation 1:

V_{N2}=V_{N3}×(1+R2/Rt) (1)

As can be seen from Equation 1, when the resistance value Rt of the variable resistor 910 decreases, the voltage V_{N2} of the output node N2 increases. When the resistance value Rt of the variable resistor 910 increases, the voltage V_{N2} of the output node N2 decreases. In brief, if the first-level operation mode signal MODE to instruct the first operation mode is provided, the resistance value of the variable resistor 910 decreases, and the voltage provider 900 outputs the first reference voltage Vref1 through the output node N2. If the second-level operation mode signal MODE to instruct the second operation mode is provided, the resistance value of the variable resistor 910 increases, and the voltage provider 900 outputs the second reference voltage Vref2 through the output node N2. In this case, the first reference voltage Vref1 has a voltage level higher than that of the second reference voltage Vref2.

An example of the variable resistor 910 is shown in FIG. 7. Referring to FIG. 7, the variable resistor 910 includes a plurality of resistors R3, R4, R5, and R6, and a transistor T. The transistor T may be a bipolar junction transistor (BJT).

The operation of the variable resistor 910 is as follows. If the low-level operation mode signal MODE to instruct the second operation mode is input, the transistor T is disabled. Accordingly, the resistance value of the variable resistor 910 becomes a resistance value of the resistor R3. If the high-level operation mode signal MODE to instruct the first operation mode is input, the transistor T is enabled, and one end of the fourth resistor R4 is connected to a ground. Accordingly, the fourth resistor R4 is connected in parallel to the third resistor R3, and the resistance value of the variable resistor 910 becomes R3×R4/(R3+R4). That is, when it is assumed that the resistance value of the variable resistor 910 is Rt, the resistance value Rt becomes R3×R4/(R3+R4) in the first operation mode, and R3 in the second operation mode. Accordingly, the resistance value Rt of the variable resistor 910 in the first operation mode is smaller than that in the second operation mode.

However, the voltage control unit may not include the shunt regulator Z, and may be implemented by various types of circuits. The variable resistor 910 is not limited to the structure shown in FIG. 7, and may be a circuit that has a resistance value that decreases when the first-level operation mode signal MODE to instruct the first operation mode is input, and increases when the second-level operation mode signal MODE to instruct the second operation mode is input.

The backlight drivers 800_1 to 800_{—}m shown in FIG. 1 are described below with reference to FIG. 8. For explanatory convenience, the case is exemplified in which the first backlight driver 800_1 controls the first light-emitting block LB1.

Referring to FIG. 8, the backlight driver 800_1 includes a current detector 810, a comparator 820, a switching unit 830, and passive elements diode D and inductor L. The backlight driver 800_1 detects the value of current flowing through the light-emitting diode (LED) and provides a detection voltage Vd having a level that corresponds to the value of the current. In addition, the backlight driver 800_1 increases the peak value of the current when the level of the detection voltage Vd is lower than the level of the first reference voltage Vref1 or the second reference voltage Vref2, but decreases the peak value of the current when the level of the detection voltage Vd is higher than the level of the first reference voltage Vref1 or the second reference voltage Vref2.

Specifically, if a switching element SW of the switching unit 830 is turned on, a power supply voltage Vin is provided to the light-emitting diode (LED), and, thus, the current flows to the current detector 810 via the light-emitting diode (LED) and an inductor L. At this time, energy by the current is stored in the inductor L. If the switching element SW of the switching unit 830 is turned off, the light-emitting diode (LED), the inductor L, and the diode D form a closed circuit, and thus the current flows through the closed circuit. At this time, the current decreases while the energy stored in the inductor L is discharged. That is, if the switching element SW of the switching unit 830 is turned on, the current gradually increases and becomes have a predetermined peak value. In contrast, if the switching element SW of the switching unit 830 is turned off, the current gradually decreases and does not flow after all.

While the switching element SW of the switching unit 830 is turned on, the current detector 810 detects the value of current flowing through the light-emitting diode (LED), and provides the detection voltage Vd having a level that corresponds to the current value. The current detector 810 may include a resistor RD.

The comparator 820 compares the first reference voltage Vref1 and the detection voltage Vd in the first operation mode, and provides the comparison result to the switching unit 830. In the first operation mode, if the level of the first reference voltage Vref1 is higher than the level of the detection voltage Vd, the comparator 820 outputs a low-level signal to the switching unit 830, and if the level of the first reference voltage Vref1 is lower than the level of the detection voltage Vd, the comparator 820 outputs a high-level signal to the switching unit 830. In addition, the comparator 820 compares the second reference voltage Vref2 and the detection voltage Vd in the second operation mode and provides the comparison result to the switching unit 830. In the second operation mode, if the level of the second reference voltage Vref2 is higher than the level of the detection voltage Vd, the comparator 820 outputs a low-level signal to the switching unit 830, and if the level of the second reference voltage Vref2 is lower than the level of the detection voltage Vd, the comparator 820 outputs a high-level signal to the switching unit 830.

The switching unit 830 includes an SR flip-flop 840 and an AND gate 850. The SR flip-flop 840 includes a reset terminal R that receives an output signal of the comparator 820 and a set terminal S that receives a clock signal CLK having a predetermined frequency. An output signal from an output terminal Q of the SR flip-flop 840 and the optical data signal LDAT are input to the AND operator 850. An output signal from the AND operator 850 is provided to the switching element SW. In this case, the switching element SW may be a MOSFET.

The operation of the switching unit 830 is as follows. If the signal output from the comparator 820 is at a high level, that is, a high-level signal is input to the reset terminal R, the SR flip-flop 840 outputs a low-level signal through the output terminal Q. At this time, the switching element SW is turned off. Meanwhile, if the signal output from the comparator 820 is at a low level, that is, a low-level signal is input to the reset terminal R and a high-level clock signal is input to the set terminal S, the SR flip-flop 840 outputs a high-level signal through the output terminal Q. In this case, the output of the AND gate 850 depends on the optical data signal LDAT. If the optical data signal LDAT is at a high level, the switching element SW is turned on.

That is, when the optical data signal LDAT is at a high level and the level of the detection voltage Vd is lower than the level of the first reference voltage Vref1 or the second reference voltage Vref2, the switching unit 830 increases the current flowing through the light-emitting diode (LED). In contrast, when the optical data signal LDAT is at a high level and the level of the detection voltage Vd is higher than the level of the first reference voltage Vref1 or the second reference voltage Vref2, the switching unit 830 decreases the current flowing through the light-emitting diode (LED). Accordingly, the current that flows through the light-emitting diode (LED) has a predetermined peak value. Here, since the level of the first reference voltage Vref1 is higher than that of the second reference voltage Vref2, the peak value of the current flowing through the light-emitting diode (LED) in the first operation mode is larger than that in the second operation mode.

In brief, if the voltage provider 900 provides the second reference voltage Vref2 in the second operation mode, the peak value of the current flowing through the light-emitting diode (LED) becomes Ipeak_2, as shown in FIG. 4B. If the voltage provider 900 provides the first reference voltage Vref1 in the first operation mode, the peak value of the current flowing through the light-emitting diode (LED) becomes Ipeak_1, as shown in FIG. 5B. In this case, the peak value Ipeak_1 is larger than the peak value Ipeak_2.

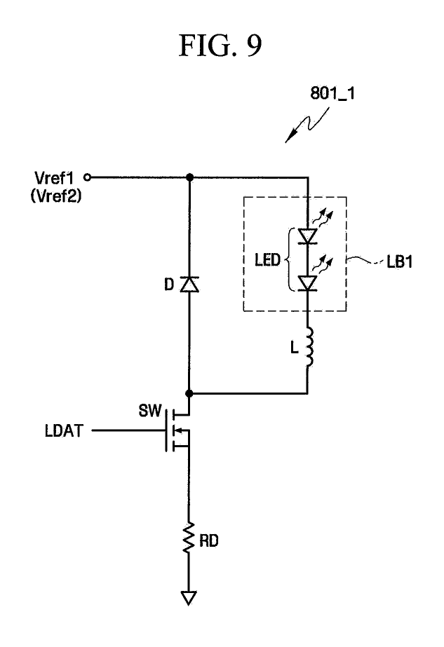

Referring to FIG. 9, a liquid crystal display and a method of driving the same according to another embodiment of the invention will be described. FIG. 9 is a circuit diagram illustrating a liquid crystal display and a method of driving the same according to another embodiment of the invention. The same constituent elements as those in FIG. 8 are denoted by the same reference numerals, and the detailed description thereof will be omitted in order to avoid the repetitive description.

Referring to FIG. 9, a backlight driver 801_1 of the liquid crystal display according to this embodiment is supplied with a first reference voltage Vref1 or a second reference voltage Vref2 as a power supply voltage. The backlight driver 801_1 of the liquid crystal display may not include the SR flip-flop 840, the AND operator 850, and the comparator 820. The optical data signal LDAT is input to a switching element SW.

The operation thereof is as follows. In a second operation mode, when the switching element SW is turned on, the light-emitting diode (LED) is supplied with the second reference voltage Vref2 as the power supply voltage and emits light. A peak value of current flowing through the light-emitting diode (LED) depends on the second reference voltage Vref2. In a first operation mode, when the switching element SW is turned on, the light-emitting diode (LED) is supplied with the first reference voltage Vref1 as the power supply voltage and emits light. In this case, the peak value of current flowing through the light-emitting diode (LED) depends on the first reference voltage Vref1. Since the level of the first reference voltage Vref1 is higher than the level of the second reference voltage Vref2, the peak value of current flowing through the light-emitting diode (LED) in the first operation mode is larger than the current flowing in the second operation mode.

What is claimed is:

1. A liquid crystal display comprising:
a liquid crystal panel; and
a plurality of light-emitting blocks providing light to the liquid crystal panel, the light-emitting blocks including light-emitting elements,
wherein a flow of a peak value of current through each of the light-emitting elements is provided as a function of an operation mode.

2. The liquid crystal display of claim 1, wherein:
the plurality of light-emitting blocks are divided into a plurality of light-emitting groups, each group including at least one light-emitting block, and
wherein in a first operation mode one frame includes a period in which at least one light-emitting group is turned off, and in a second operation mode during one frame, there is no period in which a light-emitting group is turned off.

3. The liquid crystal display of claim 2, wherein the peak value of current flowing through each of the light-emitting elements in the first operation mode is larger than a peak value of current flowing through each of the light-emitting elements in the second operation mode.

4. The liquid crystal display of claim 2, wherein:
the plurality of light-emitting blocks are arranged in a matrix, and
the light-emitting groups are rows in the matrix.

5. The liquid crystal display of claim 4, wherein the rows are sequentially turned off in the first operation mode.

6. The liquid crystal display of claim 1, wherein:
the liquid crystal panel is divided into a plurality of display blocks to correspond to the light-emitting blocks, and
the luminance of the light-emitting blocks is controlled on the basis of images displayed by the display blocks.

7. The liquid crystal display of claim 1, further comprising:
a voltage provider providing a first reference voltage in a first operation mode and a second reference voltage in a second operation mode, wherein the second reference voltage is level lower than that of the first reference voltage; and
backlight drivers coupled to receive the first reference voltage or the second reference voltage, the backlight drives being operative to control a peak value of current flowing through each of the light-emitting elements, wherein the peak value of current flowing through each of the light-emitting elements in the first operation mode is larger than a peak value of current flowing through each of the light-emitting elements in the second operation mode.

8. The liquid crystal display of claim 7,
wherein the backlight drivers detect a value of current flowing through each of the light-emitting elements and provide a detection voltage having a level corresponding to the current value, and
when the level of the detection voltage is lower than a level of the first reference voltage or the second reference voltage, the backlight drivers increase the peak value of the current, and when the level of the detection voltage is higher than the level of the first reference voltage or the second reference voltage, the backlight drivers decrease the peak value of the current.

9. The liquid crystal display of claim 7, wherein each of the backlight drivers comprises:
a current detector detecting a value of current flowing through the light-emitting element and providing a detection voltage having a level corresponding to the value of the current;
a comparator comparing the detection voltage and the first reference voltage or the second reference voltage; and
a switching unit controlling the peak value of the current according to a comparison result.

10. The liquid crystal display of claim 1, wherein the voltage provider comprises:
a first resistor connected between an input node supplied with an input voltage and an output node outputting the first reference voltage or the second reference voltage; and
a voltage control unit connected between the input node and third reference voltage, and controlling a resistance value between the input node and the third reference voltage to control a voltage of the output node in accordance with an operation mode signal.

11. The liquid crystal display of claim 10, wherein the voltage control unit comprises:
a shunt regulator connected between the output node and the third reference voltage;
a second resistor connected between the output node and a reference terminal of the shunt regulator, and
a variable resistor connected between the reference terminal and the third reference voltage and having a resistance value varying in response to the operation mode signal, the resistance value in the first operation mode being smaller than that in the second operation mode.

12. The liquid crystal display of claim 11, wherein the variable resistor comprises a switching element enabled in response to the operation mode signal at a first level and decreasing the resistance value, and disabled in response to the operation mode signal at a second level and increasing the resistance value.

13. A liquid crystal display comprising:
a liquid crystal panel divided into a plurality of display blocks;
a plurality of light-emitting blocks whose luminance is controlled on the basis of images displayed on the corresponding display blocks, the light-emitting blocks including light-emitting elements;
a voltage provider providing a first reference voltage in a first operation mode, and a second reference voltage having a level lower than that of the first reference voltage in a second operation mode; and
backlight drivers supplied with the first reference voltage or the second reference voltage and controlling a peak value of current flowing through each of the light-emitting elements,
wherein the peak value of the current in the first operation mode is larger than that in the second operation mode.

14. The liquid crystal display of claim 13, wherein:
when the plurality of light-emitting blocks are arranged in a matrix, one frame includes a period in which the light-emitting blocks corresponding to one or more rows are turned off in the first operation mode, but does not include the period in the second operation mode.

15. The liquid crystal display of claim 14, wherein the voltage provider comprises:
a first resistor connected between an input node supplied with an input voltage and an output node outputting the first reference voltage or the second reference voltage; and
a voltage control unit connected between the input node and a third reference voltage, and controlling a resistance value between the input node and the third reference voltage to control a voltage of the output node in accordance with an operation mode signal.

16. The liquid crystal display of claim 15, wherein the voltage control unit comprises:
a shunt regulator connected between the output node and the third reference voltage;
a second resistor connected between the output node and a reference terminal of the shunt regulator; and
a variable resistor connected between the reference terminal and the third reference voltage and having a resistance value varying in response to the operation mode signal, the resistance value in the first operation mode being smaller than that in the second operation mode.

17. The liquid crystal display of claim 16, wherein the variable resistor comprises a switching element enabled in response to the operation mode signal at a first level and decreasing the resistance value, and disabled in response to the operation mode signal at a second level and increasing the resistance value.

18. A method of driving a liquid crystal display that includes a liquid crystal panel, and a plurality of light-emitting blocks providing light to the liquid crystal panel, wherein the light-emitting blocks include light-emitting elements the method comprising:
controlling a peak value of current flowing through each of the light-emitting elements as a function of one or more operation modes; and
utilizing light from the light-emitting blocks to images.

19. The method of claim 18, wherein:
the plurality of light-emitting blocks are divided into a plurality of light-emitting groups each including at least one light-emitting block, and
when one frame includes a period in which at least one light-emitting group is turned off in a first operation mode, but does not include the period in a second operation mode, the controlling of the peak value of current flowing through each of the light-emitting elements comprises increasing the peak value of the current in the first operation mode and decreasing the peak value of the current in the second operation mode.

20. The method of claim 19, wherein:
the plurality of light-emitting blocks are arranged in a matrix, and
the light-emitting groups are rows in the matrix.

21. The method of claim 18, wherein:
the controlling of the peak value of current flowing through each of the light-emitting elements is providing a first reference voltage in a first operation mode and a second reference voltage having a level lower than that of the first reference voltage in a second operation mode, detecting a value of the current flowing through each of the light-emitting elements and providing a detection voltage having a level corresponding to the value of the current, and increasing the peak value of the current when the level of the detection voltage is lower than that of the first reference voltage or the second reference voltage and decreasing the peak value of the current when the level of the detection voltage is higher than that of the first reference voltage or the second reference voltage.
